(19) United States
(12) Patent Application Publication
(10) Pub. No.: US 2011/0151934 A1
(43) Pub. Date: Jun. 23, 2011

(54) Automatic Keypad Unlocking Method and Apparatus for Mobile Terminal

(75) Inventor: Qian GENG, Beijing (CN)

(73) Assignee: SONY ERICSSON MOBILE COMMUNICATIONS AB, Lund (SE)

(21) Appl. No.: 12/763,252

(22) Filed: Apr. 20, 2010

(30) Foreign Application Priority Data
Dec. 23, 2009 (CN) 200910259901.1

(51) Int. Cl. H04W 88/02

(52) U.S. Cl. 455/565

(57) ABSTRACT

The present invention provides an automatic keypad unlocking method and apparatus for mobile terminal, so as to automatically unlock a keypad when the mobile terminal is to be used. The apparatus includes: a state detecting unit configured to detect a stress state or a motion state of the mobile terminal, to recognize whether the mobile terminal is in a hand-held state based on the stress state or the motion state, and to generate a triggering signal when the mobile terminal is recognized as in the hand-held state; a camera configured to receive the triggering signal, and to capture image based on the triggering signal; a face detecting unit configured to detect a facial image from the image captured by the camera, and to generate an unlock control signal if the face detecting unit determines that a facial image of predetermined scale size is contained in the captured image; and an unlocking unit configured to receive the unlock control signal, and to automatically unlock a locked keypad based on the unlock control signal. The present invention automatically unlocks the keypad by recognizing the hand-held state of the mobile terminal.

### FIELD OF THE INVENTION

The present invention relates to the technology of unlocking a keypad in a mobile terminal, and particularly, to automatic keypad unlocking method and apparatus for mobile terminal, and a mobile terminal comprising the apparatus.

### DESCRIPTION OF THE RELATED ART

Presently, almost all mobile terminals (e.g., mobile telephones) have the functions of automatically locking the keypad and manually locking the keypad. Generally, if the user does not press a key within a specified time, the system will automatically lock the keypad to prevent the user from misoperation. The user can also manually lock the keypad by pressing special key(s), such as the lock function key(s), in a certain manner (e.g., pressing the lock function key for a long time). Once being locked, the keypad of the mobile terminal cannot enter a normal working state unless it is manually unlocked through special key(s), such as the unlock function key(s), so that the user is effectively prevented from misoperation.

However, in the prior art, if the keypad is locked, the user needs to manually unlock the keypad each time using the mobile terminal (e.g., pressing the unlock function key(s) for a long time), which is very inconvenient and takes the user's time.

### SUMMARY OF THE INVENTION

The present invention is provided in view of the above problem in the prior art. An aspect of the present invention is to provide automatic keypad unlocking method and apparatus for mobile terminal, and a mobile terminal, so as to automatically unlock a keypad when the mobile terminal is automatically judged as to be used.

An aspect according to the present invention provides an automatic keypad unlocking apparatus for a mobile terminal, comprising: a state detecting unit configured to detect a stress state or motion state of the mobile terminal, to recognize whether the mobile terminal is in a hand-held state based on the detected stress state or motion state, and to generate a triggering signal when the mobile terminal is recognized as in the hand-held state; a camera configured to receive the triggering signal, and to capture image based on the triggering signal; a face detecting unit configured to detect a facial image from the image captured by the camera, and to generate an unlock control signal if the facial image within predetermined scale size range is detected in the captured image; and an unlocking unit configured to receive the unlock control signal, and to automatically unlock a locked keypad based on the unlock control signal.

According to another aspect, the state detecting unit comprising: an acceleration sensor configured to detect an acceleration of the mobile terminal and to calculate corresponding speed of the mobile terminal; and a first triggering unit configured to recognize that the mobile terminal is in the hand-held state if the speed is within a predetermined speed range, and to generate the triggering signal.

According to another aspect, the state detection unit comprising: two or more pressure sensors respectively configured to detect pressures at two or more predetermined positions at a surface of the mobile terminal; and a second triggering unit configured to receive pressure signals outputted by the two or more pressure sensors, to recognize that the mobile terminal is in the hand-held state when the pressure signals from all the two or more pressure sensors are received, and to generate the triggering signal.

According to another aspect, the two or more predetermined positions at least include: positions at upper and lower sides of the mobile terminal or positions at left and right sides of the mobile terminal.

According to another aspect, the face detection unit is further configured to generate a feedback signal and to feed the feedback signal to the state detecting unit, when the facial image within predetermined scale size range is not detected in the captured image; the state detecting unit is configured to recognize whether the mobile terminal is in the hand-held state based on the detected stress state or motion state and a subsequently detected stress state or motion state, and to recognize the mobile terminal as not in the hand-held state if there is no change between the detected stress state or motion state and the subsequently detected stress state or motion state.

According to another aspect, the face detecting unit is further configured to generate a feedback signal and to feed the feedback signal to the first triggering unit, when the facial image within predetermined scale size range is not detected in the captured image; the first triggering unit is configured to recognize whether the mobile terminal is in the hand-held state based on the detected acceleration and an subsequently detected acceleration, and to recognize the mobile terminal as not in the hand-held state if there is no change between the next-detected acceleration and the previously detected acceleration.

According to another aspect, the face detecting unit is further configured to generate a feedback signal and to feed the feedback signal to the second triggering unit, when the facial image within predetermined scale size range is not detected in to the captured image; the second triggering unit is configured to recognize whether the mobile terminal is in the hand-held state based on the detected pressures and subsequently detected pressures at the two or more predetermined positions, and to recognize the mobile phone as not in the hand-held state if there is no change between the detected pressures and the subsequently detected pressures at any of the two or more predetermined positions.

According to another aspect, the predetermined scale size range is 50% to 100% of the size of the captured image.

Another aspect according to the present invention further provides a mobile terminal, comprising the aforementioned automatic keypad unlocking apparatus.

Another aspect according to the present invention provides an automatic keypad unlocking method for a mobile terminal, comprising: detecting a stress state or motion state of a mobile terminal, recognizing whether the mobile terminal is in a hand-held state based on the detected stress state or motion state, and triggering a camera of the mobile terminal when the mobile terminal is recognized as in the hand-held state; capturing image with the camera of the mobile terminal; detecting a facial image from the image captured by the camera; and automatically unlocking a locked keypad when the facial image within predetermined scale size range is detected in the captured image.

According to another aspect, detecting the motion state of the mobile terminal and recognizing whether the mobile terminal is in the hand-held state based on the stress state comprising: detecting an acceleration of the mobile terminal and calculating corresponding speed thereof, and recognizing that the mobile terminal is in the hand-held state if the speed is within a predetermined speed range.

According to another aspect, detecting the stress state of the mobile terminal and recognizing whether the mobile terminal is in the hand-held state based on the stress state comprising: detecting pressures at two or more predetermined positions at a surface of the mobile terminal, and recognizing that the mobile terminal is in the hand-held state when the pressures are detected from all the two or more predetermined positions.

According to another aspect, the two or more predetermined positions at least include: positions at upper and lower sides of the mobile terminal or positions at left and right sides of the mobile terminal.

According to another aspect, when the facial image within predetermined scale size range is not detected in the captured image, recognizing whether the mobile terminal is in the hand-held state based on the detected stress state or motion state and a subsequently detected corresponding stress state or motion state, and recognizing the mobile terminal as not in the hand-held state if there is no change between the detected stress state or motion state and the subsequently detected stress state or motion state.

According to another aspect, the predetermined scale size range is 50% to 100% of the size of the captured image.

With the automatic keypad unlocking method and apparatus as well as the mobile terminal provided by the present invention, a keypad can be automatically unlocked by recognizing the hand-held state of the mobile terminal, which is convenient for the user.

These and other aspects and features of the present invention will be apparent with reference to the following descriptions and attached drawings. In the following descriptions and drawings, particular embodiments of the present invention are disclosed in detail as being indicative of some of the ways in which the principles of the invention may be employed. But it is understood that the invention is not limited correspondingly in scope. Rather, the invention includes all changes, modifications and equivalents coming within the spirit and terms of the appended claims.

Features described and/or illustrated with respect to one embodiment may be used in the same way or in similar way in one or more other embodiments, and/or in combination with or instead of features of the other embodiments.

It should be emphasized that the term “include/comprise” when used in this specification is taken to specify the presence of stated features, integers, steps or components but does not preclude the presence or addition of one or more other features, integers, steps, components or groups thereof.

Many aspects of the present invention can be better understood with reference to the following drawings. The components of the drawings are not necessarily to scale, emphasis instead being placed upon clearly illustrating the principles of the present invention. To facilitate illustrating and describing some parts of the present invention, and promoting the understanding of the embodiments, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The accompanied drawings constitute a part of the Specification, for illustrating the embodiments of the present invention and elaborating the principle of the present invention together with the descriptions. Apparently, the drawings concerned in the following descriptions are just some embodiments of the present invention, and a person skilled in the art can obtain other drawings based on these drawings without paying a creative effort. In which,

FIG. 1 illustrates a structural diagram of an automatic keypad unlocking apparatus according to an embodiment of the present invention;

FIG. 2 illustrates a profile diagram of a mobile phone according to an embodiment of the present invention;

FIG. 3 illustrates a structural diagram of a state sensor according to an embodiment of the present invention;

FIG. 4 illustrates a structural diagram of an automatic keypad unlocking apparatus according to another embodiment of the present invention;

FIG. 5 illustrates a structural diagram of an automatic keypad unlocking apparatus according to another embodiment of the present invention;

FIG. 6 illustrates a structural diagram of an automatic keypad unlocking apparatus according to another embodiment of the present invention;

FIG. 7 illustrates a flowchart of an automatic keypad unlocking method according to an embodiment of the present invention; and

FIG. 8 illustrates a flowchart of an automatic keypad unlocking method according to another embodiment of the present invention.

### DETAILED DESCRIPTION OF THE PREFERRED EMBODIMENTS

The interchangeable terms “electronic apparatus” and “electronic device” include portable wireless communication apparatus. The term “portable wireless communication apparatus” which hereinafter is called as “mobile terminal”, “portable electronic apparatus” or “portable communication device”, includes all apparatuses such as mobile phones, pagers, communicators, electronic organizers, personal digital assistants (PDAs), smart phones, portable communication apparatuses, or the like.

In the present application, the embodiments of the present invention are mainly described with respect to the portable electronic apparatus in a form of mobile phone (e.g., mobile telephone). But it shall be appreciated that the present invention is not limited to the mobile phone, and may relate to an electronic apparatus of any appropriate type that has a keypad, examples of which include media player, game apparatus, PDA, computer, digital camera, etc.

To be noted, in order to avoid the present invention from being obscure due to unnecessary details, only equipment structures and/or processing steps closely related to the solution of the present invention are illustrated in the drawings, and other details having little relation to the present invention are omitted.

In order to automatically unlock a keypad of the mobile phone, it shall be judged whether the mobile phone is to be used. In the embodiments of the present invention, the stress state or the motion state of the mobile phone is detected, and whether the mobile phone is in a hand-held state (i.e., being held in hand) is recognized based on the stress state or the motion state. Then whether the mobile phone is “looked at” by a person is judged by capturing images with a camera and detecting a face from the captured image, so that whether the mobile phone is to be used can be determined. If the mobile phone is determined to be used, the keypad of the mobile phone will be unlocked automatically, thus the present invention is implemented. Detecting the stress state for example may include detecting pressures at a plurality of predetermined positions at the surface of the mobile phone, and detecting the motion state for example may include detecting the acceleration and corresponding speed of the mobile phone, but the present invention is not limited thereby.

### Embodiment 1

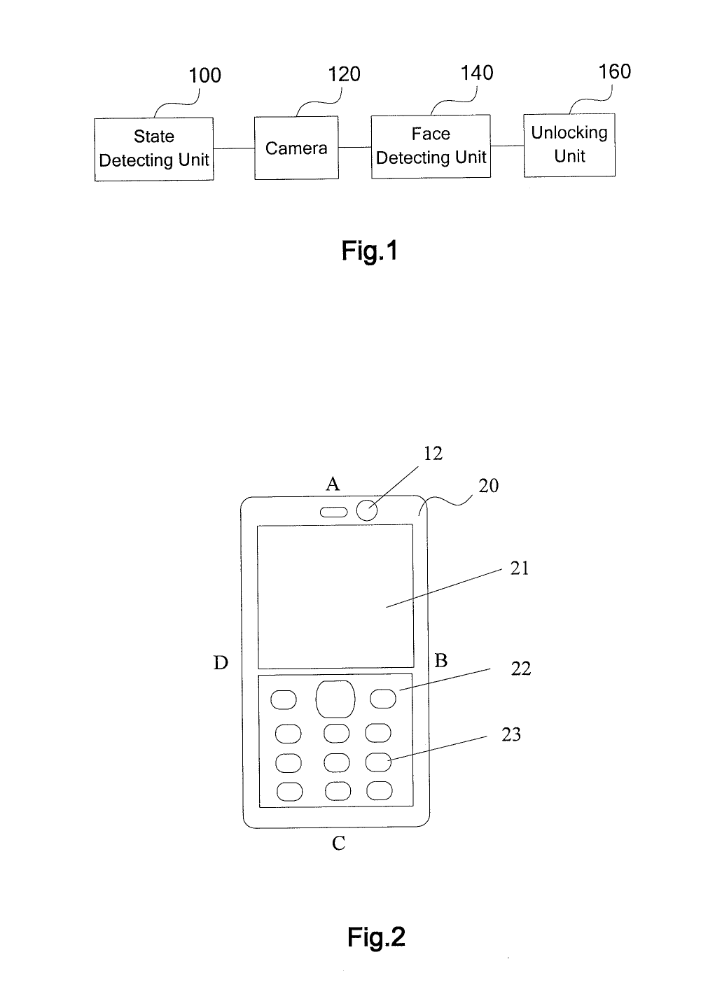

The present embodiment provides an automatic keypad unlocking apparatus that may be disposed in a mobile phone. FIG. 1 illustrates a structural diagram of an automatic keypad unlocking apparatus that may include: a state detecting unit 100, a camera 120, a face detecting unit 140 and an unlocking unit 160.

The state detecting unit 100 is configured to detect pressures at two or more predetermined positions at the surface of the mobile phone, to recognize whether the mobile phone is in a hand-held state based on the pressures applied to the two or more predetermined positions, to generate a triggering signal when the mobile phone is recognized as in the hand-held state, and to send the triggering signal to the camera 120. Generally, when using a mobile phone, the user will hold it in hand, and at that time, pressures will be produced at least a part of the positions at the peripheral side walls of the mobile phone. For example, when the mobile phone is held in hand, two opposite forces, i.e., two forces in opposite directions, will be produced at side A (upper side) and side C (lower side), or side B (right side) and side D (left side) of the mobile phone 20, as illustrated in FIG. 2. Thus, whether the mobile phone is held in hand, i.e., in a hand-held state, can be judged by detecting, using the state detecting unit, whether pressures exist at two or more predetermined positions at the surface of the mobile phone, wherein the predetermined positions may include, but not limited to, positions at opposite sides of the side walls of the mobile phone, such as upper and lower sides as well as left and right sides, and other positions may also be included, such as positions at the back face of the mobile phone.

The camera 120 is configured to receive the triggering signal from the state detecting unit 100, and to capture images based on the triggering signal. The camera 120 is started up by being triggered by the trigging signal, and then begins to capture images, wherein one image may be captured, and a plurality of images may also be captured in a certain frequency. In the present embodiment, the camera may be a prepositive camera (i.e., being disposed on the front face of the mobile phone), and may be further configured for video call and self portrait. The position of the camera illustrated in FIG. 2 is just an example, and the camera may also be disposed at other positions at the mobile phone, so long as the position enables the camera to capture a facial image when the mobile phone is used by the user. The camera may be shut off automatically when a predetermined number of images are captured, or shut off automatically after being started up for a specified time.

The face detecting unit 140 is configured to detect a facial image from one or more images captured by the camera 120, to generate an unlock control signal if it determines that at least one of the captured images includes the facial image within predetermined scale size range, and to send the unlock control signal to the unlocking unit 160. Through the state detecting unit 100, it can be determined substantially whether the mobile phone is held in hand by the user, while through the camera 120 and the face detecting unit 140, it can be further judged whether the mobile phone is “looked at” by the user. Thus it can be determined substantially whether the user wants to use the mobile phone. When a user wants to use the mobile phone, he (or she) will look at the screen of the mobile phone with his eyes, and thus his face will face the screen, at that time, the distance between the user's face and the mobile phone is generally about 40-50 cm. Under such distance, the facial image captured by the camera 120 usually will be more than 50% of the whole captured image, unless the user's face is not over against the camera 120. Therefore, when the face detecting unit 140 recognizes that the image captured by the camera 120 includes the facial image within predetermined scale size range, it deems that the user wants to use the mobile phone, and then sends the unlock control signal to the unlocking unit 160. The predetermined scale size range may be set as occupying 50% to 100% of the size of the captured image, herein 50% is just an example, the present invention is not limited thereby, and larger or smaller values may also be adopted. In one embodiment of the present invention, the face detection algorithm adopted by the face detecting unit 140 may be that used in the prior art, e.g., AdaBoost algorithm (see reference literature: Yoav Freund, etc., “A decision-theoretic generalization of on-line learning and an application to boosting”, Journal of Computer and System Sciences, 55(1):119-139, August 1997) and the like, and also may be other face detecting algorithm currently used or to be used in the future.

The unlocking unit 160 is configured to receive the unlock control signal from the face detecting unit 140, and to automatically unlock the locked keypad based on the unlock control signal. For example, as illustrated in FIG. 2, after receiving the unlock control signal, the unlocking unit 160 unlocks the keypads 23 in a keypad area 22.

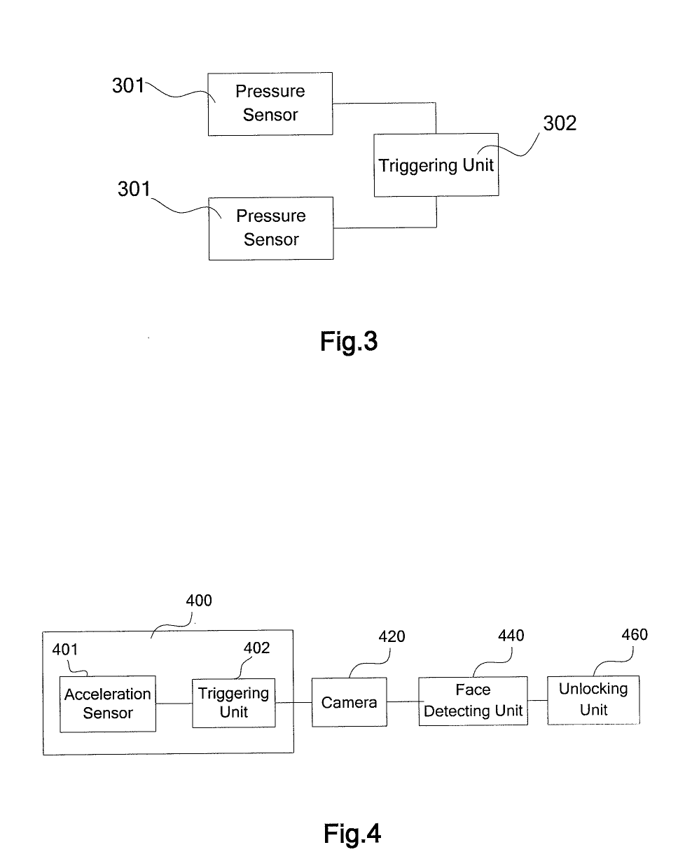

In one embodiment of the present invention, as illustrated in FIG. 3, the state detecting unit 100 may further include: two or more pressure sensors 301 and triggering units 302.

The two or more pressure sensors 301 are respectively configured to detect pressures applied to two or more predetermined positions at the surface of the is mobile phone. The two or more predetermined positions at least include: positions at the upper and lower sides or the left and right sides of the mobile phone. Therefore, in one embodiment of the present invention, two pressure sensors 301 are disposed at the left and right sides of the mobile telephone, i.e., sides B and D as illustrated in FIG. 2. In another embodiment of the present invention, two pressure sensors 301 are disposed at the upper and lower sides of the mobile telephone, i.e., sides A and C as illustrated in FIG. 2. In another embodiment of the present invention, in addition to the two sides of the mobile phone, the pressure sensor 301 may also be disposed at the back face of the mobile phone at the same time, so as to judge that the mobile phone is in the hand-held state when pressures are detected at the two sides and the back face simultaneously. Here, the two or three pressure sensors 301 are just exemplary, and more pressure sensors can be disposed on the mobile phone.

The triggering unit 302 is configured to receive pressure signals outputted by the two or more pressure sensors 301, to recognize whether the mobile phone is in the hand-held state based on the pressure signals outputted by the two or more pressure sensors 301, to generate the triggering signal when the mobile phone is recognized as in the hand-held state, and to send the triggering signal to the camera 120, so as to trigger the start-up of the camera 120. Specifically, the triggering unit 302 can recognize that the mobile phone is in the hand-held state when receiving the pressure signals from the two or more pressure sensors, and send a triggering signal to the camera 120. If the triggering unit 302 only receives the pressure signal from a part of the two or more pressure sensors, it judges that the mobile phone is not in the hand-held state. For example, when the mobile phone is placed in a pocket, hand bag or at other position, a pressure is probably produced only at one side of the mobile phone. And if the triggering unit 302 only receives the pressure signal from the pressure sensor at one side, it judges that the mobile phone is not in the hand-held state, and does not generate any triggering signal.

The automatic keypad unlocking apparatus with the above structure according to the embodiment of the present invention can automatically unlock the keypad when the mobile phone is used by the user, hence it overcomes the inconvenience caused by manual unlocking in the prior art.

### Embodiment 2

The present embodiment further provides another automatic keypad unlocking apparatus, which has a state detecting unit different from that in Embodiment 1.

The state detecting unit in Embodiment 1 is configured to detect the pressures applied to two or more predetermined positions at the surface of the mobile phone, to recognize whether the mobile phone is in a hand-held state based on the pressures detected at the two or more predetermined positions, and to trigger the camera of the mobile phone when recognizing that the mobile phone is in the hand-held state. The state detecting unit in Embodiment 2 is configured to detect the acceleration and corresponding speed of the mobile phone, and to recognize that the mobile phone is in a hand-held state when the detected speed is within a predetermined speed range, so as to trigger the camera of the mobile phone.

FIG. 4 illustrates a structural diagram of an automatic keypad unlocking apparatus according to the present embodiment. As illustrated in FIG. 4, the automatic keypad unlocking apparatus includes: a state detecting unit 400, a camera 420, a face detecting unit 440 and an unlocking unit 460. Since there is no change as compared with the camera 120, the face detecting unit 140 and the unlocking unit 160 in Embodiment 1, the camera 420, the face detecting unit 440 and the unlocking unit 460 in Embodiment 2 are not described herein, and only the state detecting unit 400 is described in emphasis. In the present embodiment, the state detecting unit 400 includes an acceleration sensor 401 and a triggering unit 402.

The acceleration sensor 401 is configured to detect an acceleration of the mobile phone and to calculate corresponding speed of the mobile phone. Here, the corresponding speed of the mobile phone is a speed in relation to the mobile phone holder. Before the speed of the mobile phone is changed (i.e., before the acceleration is produced), the initial speed of the mobile phone is deemed as 0, which avoids the influence of the moving speed of the mobile phone holder.

The triggering unit 402 is configured to receive the acceleration value and the speed value from the acceleration sensor 401, to compare the speed value with a prestored or preset speed range, to recognize that the mobile phone is in the hand-held state if the speed value is within the speed range, and then to generate a triggering signal. If the speed value is not within the speed range, the triggering unit 402 recognizes that the mobile phone is not in the hand-held state, and then does not generate a triggering signal. Generally, when the user wants to use the mobile phone, he will pick up or take out the mobile phone from a certain position (e.g., a desk, a pocket or a school bag), at that time, the speed of the mobile phone certainly changes, and acceleration will be produced. Meanwhile, when the mobile phone is moved by the hand, a moving speed of the mobile phone in relation to the user is within a certain speed range, e.g., 0.2-2 m/s. The moving speed can be calculated based on the acceleration-time relation detected by the acceleration sensor, but the concrete calculation method is the prior art, and the detailed description is omitted herein. Thus the triggering unit can preliminarily judge (i.e., recognized) whether the mobile phone is held in hand, i.e., in the hand-held state based on the acceleration and speed of the mobile phone. Here, the certain speed range of 0.2-2 m/s is just an example, and the present invention is not limited thereby. If the mobile phone is recognized as in the hand-held state, a triggering signal will be sent to the camera 420. After the triggering signal is received, the processing by the camera 420 and subsequent processing by the face detecting unit 440 and the unlocking unit 460 are same as those described in Embodiment 1.

The automatic keypad unlocking apparatus in Embodiment 2 can also unlock the keypad automatically when the mobile phone is used by the user.

### Embodiment 3

The present embodiment further provides another automatic keypad unlocking apparatus.

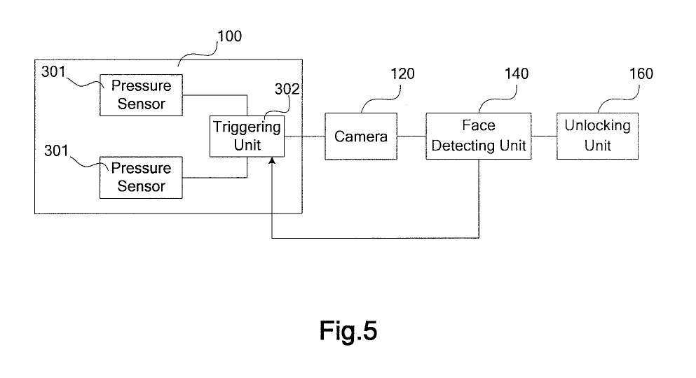

When the automatic keypad unlocking apparatus of Embodiments 1 is used, the following possibility may occur. When the mobile phone is placed at a position such as pocket or handbag, pressures may occur at two or more predetermined positions (e.g., the left and right sides or the upper and lower sides) of the mobile phone at the same time. And if the state detecting unit detects the pressures at theses positions simultaneously, it will produce a triggering signal and transmit to the camera. At that time, the camera will starts up to capture images. Although it is recognized that the user will not use the mobile phone after a face detection among the captured images via the face detecting unit, and no unlock control signal will be sent to the unlocking unit to unlock the keypad, the state detecting unit will continuously send triggering signals to the camera if pressures occur at two or more predetermined positions at the mobile phone constantly or frequently. Thus the camera frequently captures images and wastes much electric power. In order to prevent the camera from frequently capturing images when the face detecting unit does not detect a face, Embodiment 3 provides an automatic keypad unlocking apparatus as illustrated in FIG. 5. Since the automatic keypad unlocking apparatus as illustrated in FIG. 5 is substantially same as that in Embodiment 1, the reference signs adopted in Embodiment 1 are still used herein, descriptions of the same parts are omitted, and attention is only paid to the differences, which are described as follows.

The face detecting unit 140 is further configured to generate a feedback signal and to feed the feedback signal to the state detecting unit 100, e.g., to the triggering unit 302 in the state detecting unit 100, when the facial image within predetermined scale size range is not contained in the captured image.

The triggering unit 302 recognizes whether the mobile phone is in a hand-held state based on the detected pressures and subsequently detected pressures at the two or more predetermined positions. If there is no change between the detected pressures and the subsequently detected pressures at any of the two or more predetermined positions, the mobile phone is recognized as not in the hand-held state, even if the pressure signals from the two or more pressure sensors are received at the same time. This prevents unnecessary triggering signals being sent to the camera when the mobile phone is pressed in a pocket or handbag. If there is any change between the detected pressures and the subsequently detected pressures at any of the two or more predetermined positions, and the pressure signals from the two or more pressure sensors are received at the same time, the mobile phone is recognized as in the hand-held state.

The mobile phone with the above structure according to the embodiment of the present invention can automatically unlock the keypad when the mobile phone is used by the user, thus overcome the inconvenience caused by manual unlocking in the prior art. It also prevents unnecessary triggering signals being constantly sent to the camera when the mobile phone is not in the hand-held state but still under a constant pressure at predetermined position, so as to reduce power consumption.

### Embodiment 4

The present embodiment further provides another automatic keypad unlocking apparatus.

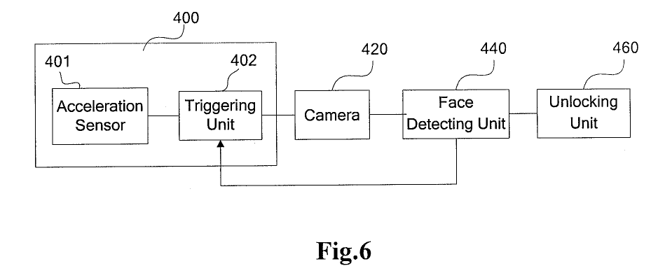

Embodiment 4 provides automatic keypad unlocking apparatus as illustrated in FIG. 6, which is substantially same as that in Embodiment 2. The reference signs adopted in Embodiment 2 are still used herein, descriptions of the same parts are omitted, and attention is paid to the differences, which are described as follows.

The face detecting unit 440 is further configured to generate a feedback signal and to feed the feedback signal to the state detecting unit 400, e.g., to the triggering unit 402 in the state detecting unit 400, when the facial image within predetermined scale size range is not contained in the captured image.

The triggering unit 402 recognizes whether the mobile phone is in a hand-held state based on the detected acceleration and a subsequently detected acceleration by the acceleration sensor. If there is no change between the acceleration and the subsequently detected acceleration, the mobile phone is recognized as not in the hand-held state. This prevents unnecessary triggering signals being sent to the camera when the mobile phone is under a constant acceleration but is not held in hand, e.g., when the mobile phone holder is in an accelerated train. If a subsequently detected acceleration is received from the acceleration sensor, and there is any change between the subsequently detected acceleration and the detected acceleration preceding the subsequently detected acceleration, the mobile phone is recognized as in the hand-held state.

The present embodiment also prevents unnecessary triggering signals being constantly sent to the camera when the mobile phone is not in the hand-held state but still under a constant acceleration, so as to reduce the power consumption.

### Embodiment 5

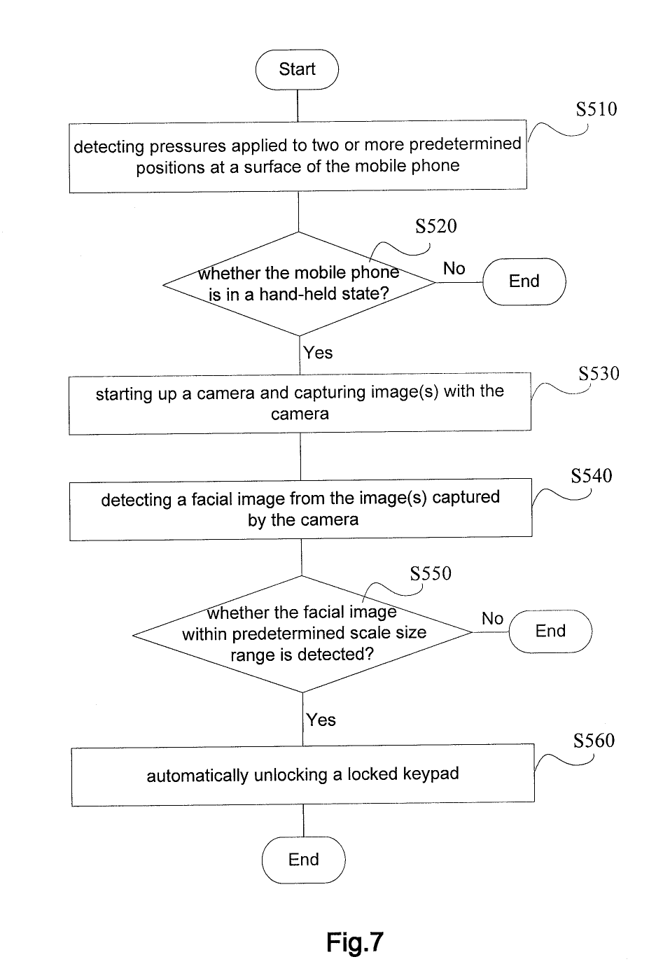

The present embodiment provides an automatic keypad unlocking method. FIG. 7 illustrates a flowchart of an automatic keypad unlocking method according to an embodiment of the present invention, including the steps of:

Step S510: detecting pressures applied to two or more predetermined positions at a surface of the mobile phone, wherein the two or more predetermined positions may include: positions at the upper and lower sides of the mobile terminal or positions at the left and right sides of the mobile terminal.

Step S520: recognizing whether the mobile phone is in a hand-held state based on the pressures applied to the two or more predetermined positions. The mobile phone is recognized as in the hand-held state when pressures are detected at the two or more predetermined positions, otherwise not in the hand-held state; the flow will be ended if the mobile phone is recognized as not in the hand-held state.

Step S530: starting up a camera of the mobile phone if the mobile phone is recognized as in the hand-held state, and capturing image(s) with the camera of the mobile phone.

Step S540: detecting a face from the image(s) captured by the camera; and

Step S550: determining whether a facial image within predetermined scale size range is contained in the captured image; wherein the predetermined scale size range is, but not limited to, 50% to 100% of the size of the captured image; and the flow will be ended if the facial image within predetermined scale size range is determined as not contained in the captured image.

Step S560: automatically unlocking the keypad when the facial image within predetermined scale size range is determined as contained in the captured image.

In another preferred embodiment of the present invention, the method may further include: when the facial image within predetermined scale size range is determined as not contained in the captured image, in the recognizing step S520 of subsequent procedure, determining whether the mobile phone is in the hand-held state based on the changes between subsequently detected pressures and the detected pressures preceding the subsequently detected pressures applied to the two or more predetermined positions until the keypad is automatically unlocked. If the detected pressures applied to any of the two or more predetermined positions do not change all along, the mobile phone will be recognized as not in the hand-held state.

The method according to the present embodiment can automatically unlock the keypad when the mobile phone is used by the user, hence it overcomes the inconvenience caused by manual unlocking in the prior art, and reduces the power consumption as much as possible.

### Embodiment 6

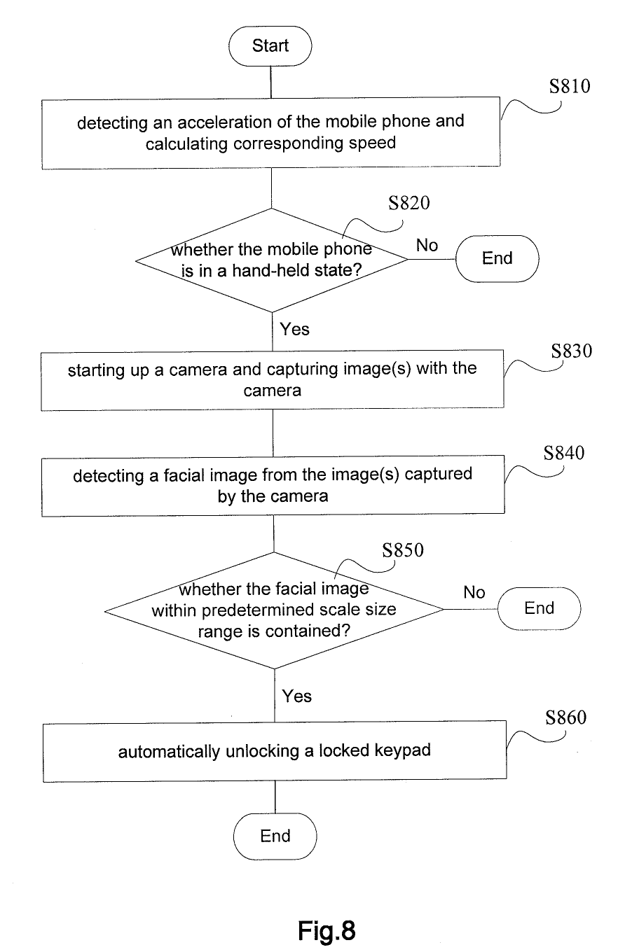

The present embodiment further provides another automatic keypad unlocking method. FIG. 8 illustrates a flowchart of an automatic keypad unlocking method according to the embodiment of the present invention, including the steps of:

Step S810: detecting an acceleration of the mobile phone and calculating corresponding speed. Here, the corresponding speed is a speed change caused by the detected acceleration, i.e., a speed of the mobile phone in relation to the mobile phone holder. Before the speed of the mobile phone is changed (i.e., before the acceleration is produced), the initial speed of the mobile phone is deemed as 0, which avoids the influence of the moving speed of the mobile phone holder.

Step S820: recognizing that the mobile phone is in a hand-held state when the speed is within a predetermined speed range, and recognizing that the mobile phone is not in a hand-held state when the speed is not within the predetermined speed range. The flow will be ended if the mobile phone is recognized as not in the hand-held state.

Step S830: starting up a camera of the mobile phone if the mobile phone is recognized as in the hand-held state, and capturing image(s) with the camera of the mobile phone.

Step S840: detecting a face from the image(s) captured by the camera; and

Step S850: determining whether a facial image within predetermined scale size range is contained in the captured image; wherein the predetermined scale size range is, but not limited to, 50% to 100% of the size of the captured image. The flow will be ended if the facial image within predetermined scale size range is determined as not contained in the captured image.

Step S860: automatically unlocking the keypad when the facial image within predetermined scale size range is determined as contained in the captured image.

In another preferred embodiment of the present invention, the method may further include: when the facial image within predetermined scale size range is determined as not contained in the captured image, determining whether the mobile phone is in the hand-held state based on change of detected acceleration of the mobile phone. If there is no change between the subsequently detected acceleration and the detected acceleration preceding the subsequently detected acceleration, the mobile phone is recognized as not in the hand-held state.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts or otherwise described herein may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams or otherwise described herein, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for/ means configured to ” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, apparatus, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An automatic keypad unlocking apparatus for a mobile terminal, comprising:
a state detecting unit configured to detect a stress state or -motion state of the mobile terminal, to recognize whether the mobile terminal is in a hand-held state based on the detected stress state or motion state, and to generate a triggering signal when the mobile terminal is recognized as in the hand-held state;
a camera configured to receive the triggering signal, and to capture image based on the triggering signal;
a face detecting unit configured to detect a facial image from the image captured by the camera, and to generate an unlock control signal if the face detecting unit determines that a facial image of predetermined scale size is contained in the captured image; and
an unlocking unit configured to receive the unlock control signal, and to automatically unlock a locked keypad based on the unlock control signal.

2. The apparatus according to claim 1, wherein the state detecting unit comprising:
an acceleration sensor configured to detect an acceleration of the mobile terminal and to calculate corresponding speed of the mobile terminal; and
a first triggering unit configured to recognize that the mobile terminal is in the hand-held state if the speed is within a predetermined speed range, and to generate the triggering signal.

3. The apparatus according to claim 1, wherein the state detecting unit comprising:
two or more pressure sensors respectively configured to detect pressures at two or more predetermined positions at a surface of the mobile terminal; and
a second triggering unit configured to receive pressure signals outputted by the two or more pressure sensors, to recognize that the mobile terminal is in the hand-held state when the pressure signals from all the two or more pressure sensors are received, and to generate the triggering signal.

4. The apparatus according to claim 3, wherein the two or more predetermined positions at least comprise: positions at upper and lower sides of the mobile terminal or positions at left and right sides of the mobile terminal.

5. The apparatus according to claim 1, wherein the face detecting unit is further configured to generate a feedback signal and to feed the feedback signal to the state detecting unit, when the facial image of predetermined scale size is determined as not contained in the captured image;
the state detecting unit is configured to recognize whether the mobile terminal is in the hand-held state based on a subsequently detected stress state or motion state of the mobile terminal and the change between the subsequently detected stress state or motion state and its previously detected stress state or motion state, and to recognize the mobile terminal as not in the hand-held state if there is no change between the subsequently detected stress state or motion state and its previously detected stress state or motion state.

6. The apparatus according to claim 2, wherein the face detecting unit is further configured to generate a feedback signal and to feed the feedback signal to the first triggering unit, when the facial image of predetermined scale size is determined as not contained in the captured image;
the first triggering unit is configured to recognize whether the mobile terminal is in the hand-held state based on a subsequently detected acceleration of the mobile terminal by the acceleration sensor and the change of corresponding speed, and to recognize the mobile terminal as not in the hand-held state if there is no change between the subsequently detected acceleration and its previously detected acceleration.

7. The apparatus according to claim 3, wherein the face detecting unit is further configured to generate a feedback signal and to feed the feedback signal to the second triggering unit, when the facial image of predetermined scale size is determined as not contained in the captured image;
the second triggering unit is configured to recognize whether the mobile terminal is in the hand-held state based on a subsequently detected pressures by the two or more pressure sensors and the changes between the subsequently detected pressures and their previously detected corresponding pressures, and to recognize the mobile phone as not in the hand-held state if there is no change between the subsequently detected pressures and their previously detected pressures by any of the two or more pressure sensors.

8. The apparatus according to claim 1, wherein the predetermined scale size is 50% to 100% of the size of the captured image.

9. A mobile terminal, comprising the automatic keypad unlocking apparatus according to claim 1.

10. An automatic keypad unlocking method for a mobile terminal, comprising:
detecting a stress state or motion state of a mobile terminal, recognizing whether the mobile terminal is in a hand-held state based on the detected stress state or motion state, and triggering a camera of the mobile terminal when the mobile terminal is recognized as in the hand-held state;
capturing image with the camera of the mobile terminal;
detecting a facial image from the image captured by the camera; and
automatically unlocking a locked keypad when a facial image of predetermined scale size is determined as contained in the captured image.

11. The method according to claim 10, wherein detecting the motion state of the mobile terminal and recognizing whether the mobile terminal is in the hand-held state based on the stress state comprising:
detecting an acceleration of the mobile terminal and calculating corresponding speed thereof, and recognizing that the mobile terminal is in the hand-held state if the speed is within a predetermined speed range.

12. The method according to claim 10, wherein detecting the stress state of the mobile terminal and recognizing whether the mobile terminal is in the hand-held state based on the stress state comprising:
detecting pressures at two or more predetermined positions at a surface of the mobile terminal, and recognizing that the mobile terminal is in the hand-held state when the pressures are detected from all the two or more predetermined positions.

13. The method according to claim 12, wherein the two or more predetermined positions at least comprise: positions at upper and lower sides of the mobile terminal or positions at left and right sides of the mobile terminal.

14. The method according to claim 10, further comprising:
when the facial image of predetermined scale size is determined as not contained in the captured image, recognizing whether the mobile terminal is in the hand-held state based on a subsequently detected stress state or motion state of the mobile terminal and the change between the subsequently detected stress state or motion state and its previously detected corresponding stress state or motion state, and recognizing the mobile terminal as not in the hand-held state if there is no change between the subsequently detected stress state or motion state and its previously detected stress state or motion state.

15. The method according to claim 10, wherein the predetermined scale size is 50% to 100% of the size of the captured image.
